(19) United States
(12) Patent Application Publication
(10) Pub. No.: US 2009/0210827 A1
(43) Pub. Date: Aug. 20, 2009

(54) Web navigation user interface for orienting and organizing navigation links

(76) Inventors: Thomas Stanton Brugler, Fuquay-Varina, NC (US); Todd Michael Eischeid, Cary, NC (US); Mark E. Molander, Cary, NC (US); Kerry A. Ortega, Raleigh, NC (US)

Correspondence Address: MAXVALUEIP CONSULTING LLC, 11204 ALBERMYRTLE ROAD, POTOMAC, MD, 20854, US

(21) Appl. No.: 12/031,746

(22) Filed: Feb. 15, 2008

(51) Int. Cl. G06F 3/048

(52) U.S. Cl. 715/854

(57) ABSTRACT

This embodiment, a navigation module, includes two unique features to address two long standing usability problems associated with today's current navigation scheme. First, it contains a selector that allows the end-user to change the layout of the navigation area relative to the content area. That is, the user can elect to view the navigation area in a horizontal or vertical layout by selecting the orientation toggle. Second, it provides alternative views to the standard hierarchical tree-structure. By retaining individual end-user usage data, the navigation module provides views where the links are sorted by frequency of use and access date/time.

### BACKGROUND OF THE INVENTION

Central to many of today's web applications is the pairing between the navigation and the content areas. The navigation area is used to present the various links, which the end-user can select, and display its contents in the contents area. Although this paradigm has received great success, there are a number of design issues that have limited the overall usability of the paradigm. Some of these usability issues are as explained as follows.

One limitation is the fixed layout of the navigation area relative to the content area. Early in the design process, the web designer must choose between one two layouts; a left-right or a top-down layout. Once selected, the layout is fixed. This can limit the resulting usability experience in a number of ways. First, there is some content area that might have strong horizontal dimension. To illustrate, using the left-right layout, the end-user might not be able to see the entire content area without horizontal scrolling (as shown in FIG. 1). To minimize this problem, many designers have used a collapsible section to show/hide the navigation area. The problem with collapsible sections is that the end-user must expand the navigation area (if collapsed), to select another link. Another problem with fixed layouts is that it cannot accommodate individual preference for left-right or top-down orientations. Some users may be accustomed to the navigation presented vertically, while others may be accustomed to the navigation presented horizontally. Therefore, having a fixed orientation may only satisfy a subset of the user community.

Another usability limitation rests on the fact that the navigation area presents links as fixed tree-structure. For web application that contain a relatively few number of links, this is not a major usability concern; however, as the number of links grows, the end-user is given the burden of learning and remembering the tree structure. This is especially true if the tree's node names aren't meaningful, or a link's function could place it in one of several different branches. End-users may experience frustration for not being able to locate a link used previously.

A navigation widget provides user control options designed to address such design limitations.

### SUMMARY OF THE INVENTION

One embodiment, a navigation widget, includes two unique features to address two long standing usability problems associated with today's current navigation scheme. First, the proposed widget contains a selector that allows the end-user to change the layout of the navigation area relative to the content area. That is, the user can elect to view the navigation area in a horizontal or vertical layout by selecting the orientation toggle. Second, the navigation widget provides alternative views to the standard hierarchical tree-structure. By retaining individual end-user usage data, the navigation widget provides views where the links are sorted by frequency of use and access date/time by the same user. This feature can save the user an enormous amount of time of try and error work to find the desired link.

### BRIEF DESCRIPTION OF THE DRAWINGS

FIG. 1 shows the navigation and content areas displayed in a left-right layout.

FIG. 2 shows the navigation and content areas displayed in a top-down layout.

FIG. 3 illustrates navigation area displaying links in a standard layout.

FIG. 4 illustrates navigation area displaying links in a recency layout.

FIG. 5 shows navigation area displaying links in a frequency of use layout.

### DETAILED DESCRIPTION OF THE PREFERRED EMBODIMENTS

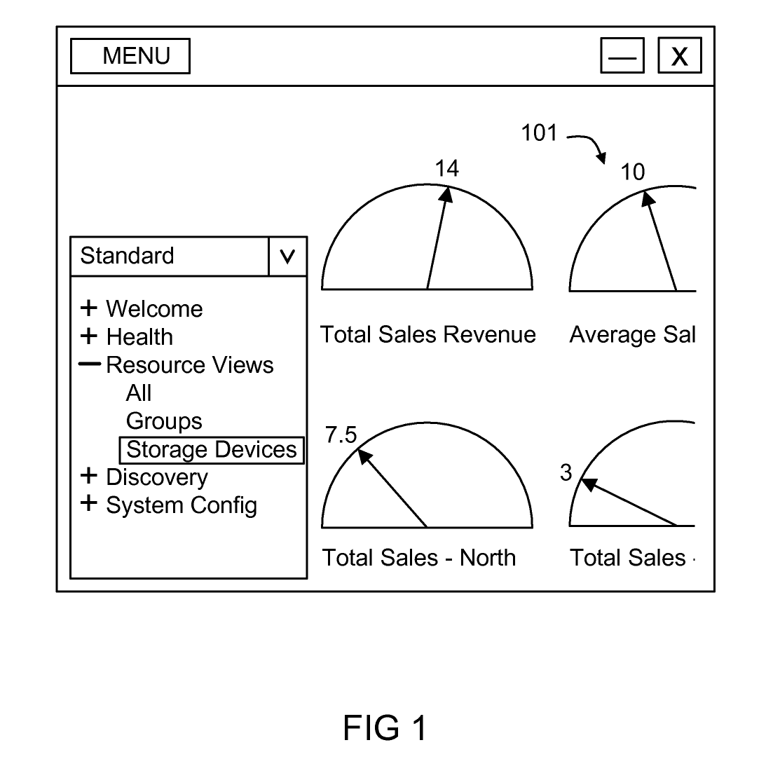

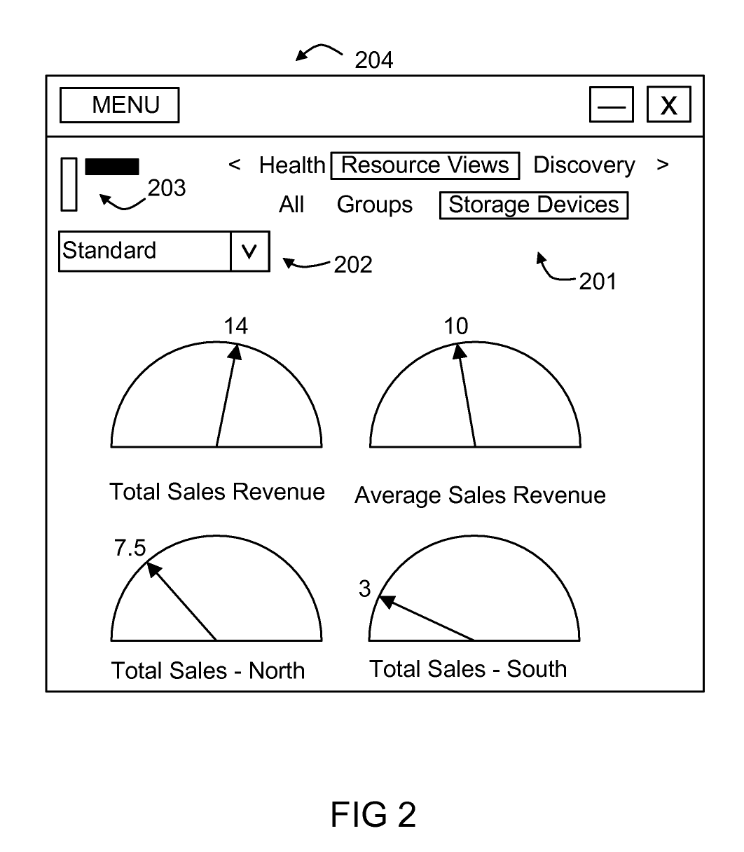

In one embodiment, this helps overcome limited options in layout selection. This navigation widget contains two unique features. A feature of this invention, 203 in FIG. 2, changes the orientation of the navigation bar (horizontal/vertical). As shown in FIG. 1, when the navigation area is aligned in a vertical orientation in a prior art, not all gauges in the content area are completely visible: Item 101 is not completely shown. However, as shown in FIG. 2, by selecting the horizontal orientation layout icon 203, the end-user can fully view all the gauges presented in the content area. Also referring to FIG. 2, the end-user can select other links without expanding/collapsing the groups in the navigation area (201 of FIG. 2).

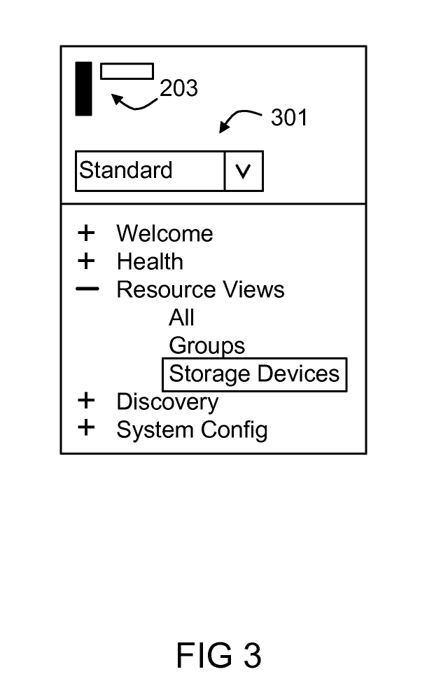

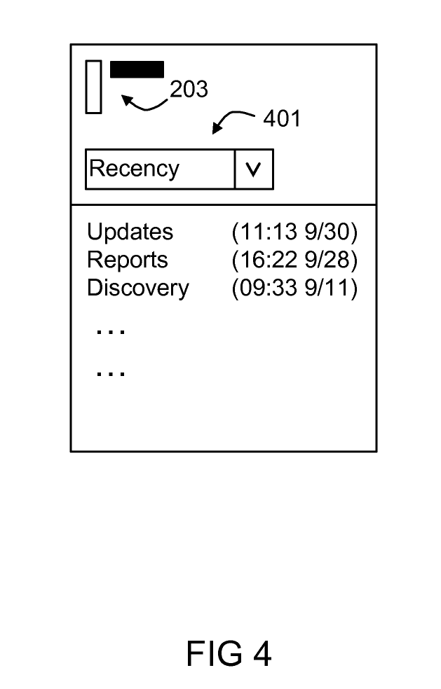

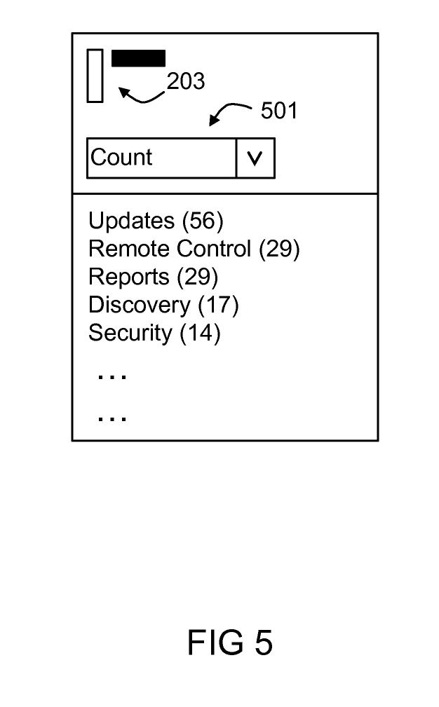

Another unique feature of this invention allows the end-user to change the view in which links are displayed. As shown in FIG. 3, the user can select the standard applications view (301) which is the regular method currently used. He/she can elect to view the links by recency of use (401), i.e. sorted by last used date/time, as shown in FIG. 4, or alternatively, by frequency of use (501), i.e. sorted by the number of times it has been accessed since a specified time in the past (count), as depicted in FIG. 5. Again, the recency of use (401) and frequency views (501) are both based on the individual end-user usage.

In the preferred embodiment of this invention, a system for providing a web interface on a web site is presented, such that the system comprises of an orientation selector control (203 of FIG. 2) associated with the web interface (204 of FIG. 2), a link view type selector (202 of FIG. 2) associated with the web interface (204), a navigation bar (201) associated with the web interface (204), a plurality of web links within the navigation bar, a main view associated with the web interface for displaying a content, and a storage for storing the time and the frequency of the user selecting the first one of the plurality of web links.

In this embodiment, the navigation bar is displayed in horizontal or vertical orientation. A user can select the orientation selector control (203) to toggle the orientation of the navigation bar between vertical and horizontal, and the toggle in the orientation of the navigation bar modifies the main layout.

Furthermore, in this embodiment, the system tracks a time and a frequency of the user selecting any first one of the plurality of web links. Link view type selector (202) provides to the user one of view selection options comprising of hierarchy (301), recency (401), and frequency (501). If the recency view selection option (401) is selected, then the system queries the storage to determine a most recent time of the user selecting the first one of the plurality of web links, and the system displays the plurality of web links and the most recent time of the user selecting the first one of the plurality of web links, sorted based on a descending order of the most recent time of the user selecting the first one of the plurality of web links, in the navigation bar.

If the frequency view selection (501) option is selected, then the system queries the storage to determine the frequency of the user selecting the first one of the plurality of web links, and the system displays the plurality of web links and the frequency of the user selecting the first one of the plurality of web links, sorted based on a descending order of the frequency of the user selecting the first one of the plurality of web links, in the navigation bar.

If the hierarchy view selection option (301) is selected and the system is displaying the navigation bar in horizontal orientation, then the system displays a plurality of hierarchy elements on a top row in the navigation bar (201) with one of the plurality of hierarchy elements being selected, and the system displays a first subset of the plurality of web links associated with the selected one of the plurality of hierarchy elements in a bottom row in the navigation bar.

If the hierarchy view selection option is selected and the system is displaying the navigation bar in vertical orientation, then as shown in FIG. 3, the system displays the plurality of hierarchy elements as nodes of a collapsible tree structure with a second subset of the plurality of web links associated with each one of the nodes of the collapsible tree structure displayed under corresponding to each one of the nodes, in the navigation bar.

The present invention can also be implemented in other browsing applications such as picture viewers. Such software applications usually offer a page which shows the thumbnail pictures of each of the several albums upon selection. The width or height of the page can often be inadequate to show the whole page. It is beneficial if the orientation of the page can easily be changed from horizontal to vertical or vice versa in order to show some of the area not shown in either orientation. More importantly, in current navigation bars, to find a previously seen picture album, the user needs to rely on memory or try/error. By applying the present invention, the user can find the album which he has recently viewed or has most frequently seen over the past specified period of time. This embodiment helps saving the user enormous amount of time and effort to get to the right information in an improved fashion.

A method, apparatus, or device comprising one of the following items is an example of the invention: web navigation, menu, screen, UT, GUI, windows, working area, server, client device, PDA, mobile device, cell phone, storage to store the messages, router, switches, network, communication media, cables, fiber optics, physical layer, buffer, nodes, packet switches, computer monitor, or any display device, applying the method mentioned above, for the purpose of organizing web navigation.

Any variations of the above teaching are also intended to be covered by this patent application.

1. A system for providing a web interface on a web site, said system comprising of:
an orientation selector control associated with said web interface;
a link view type selector associated with said web interface;
a navigation bar associated with said web interface;
a plurality of web links within said navigation bar;
a main view associated with said web interface for displaying a content;
wherein said navigation bar is displayed in horizontal or vertical orientation;
wherein a user selects said orientation selector control to toggle the orientation of said navigation bar between vertical and horizontal; and appearance of said orientation selector control changes based on selected orientation of said navigation bar; and when width and height of a page is not enough to show entire said page, orientation of said page is changed from vertical to horizontal or from horizontal to vertical;
wherein said toggle in the orientation of said navigation bar modifies a layout of said main view;
wherein said system tracks a time and a frequency of said user selecting any first one of said plurality of web links;
a storage for storing said time and said frequency of said user selecting said first one of said plurality of web links;
wherein said link view type selector provides to said user one of view selection options comprising of hierarchy, recency, and frequency;
wherein if said recency view selection option is selected, then said system queries said storage to determine a most recent time of said user selecting said first one of said plurality of web links, and said system displays said plurality of web links and said most recent time of said user selecting said first one of said plurality of web links, sorted based on a descending order of said most recent time of said user selecting said first one of said plurality of web links, in said navigation bar;
wherein if said frequency view selection option is selected, then said system queries said storage to determine said frequency of said user selecting said first one of said plurality of web links, and said system displays said plurality of web links and said frequency of said user selecting said first one of said plurality of web links, sorted based on a descending order of said frequency of said user selecting said first one of said plurality of web links, in said navigation bar;
wherein if said hierarchy view selection option is selected and said system is displaying said navigation bar in horizontal orientation, then said system displays a plurality of hierarchy elements on a top row in said navigation bar with one of said plurality of hierarchy elements being selected, and said system displays a first subset of said plurality of web links associated with said selected one of said plurality of hierarchy elements in a bottom row in said navigation bar; and
wherein if said hierarchy view selection option is selected and said system is displaying said navigation bar in vertical orientation, then said system displays said plurality of hierarchy elements as nodes of a collapsible tree structure with a second subset of said plurality of web links associated with each one of said nodes of said collapsible tree structure displayed under corresponding said each one of said nodes, in said navigation bar.
